(19) United States
(12) Patent Application Publication
(10) Pub. No.: US 2014/0191567 A1
(43) Pub. Date: Jul. 10, 2014

(54) METER WITH PROJECTOR FOR VEHICLE

(71) Applicants: DENSO INTERNATIONAL AMERICA, INC., Southfield, MI (US); DENSO CORPORATION, Kariya-shi (JP)

(72) Inventor: Hiroshi Tominaga, Okazaki-shi (JP)

(73) Assignees: DENSO CORPORATION, Kariya-shi (JP); DENSO International America, Inc., Southfield, MI (US)

(21) Appl. No.: 13/736,301

(22) Filed: Jan. 8, 2013

(51) Int. Cl. H05K 7/00

(52) U.S. Cl. CPC H05K 7/00
USPC 307/9.1

(57) ABSTRACT

A meter device for a vehicle has a meter module protruded on a dashboard. A chassis module installed in the dashboard is extending on a front side of the meter module. The chassis module has a projection module having a laser light source and a reflector. The chassis module further has an indicator module which displays a character or a sign. The chassis module, the meter module, the indicator module, and the projection module are formed in an assembly which can be handled as a single unit. The projection module projects an image on the meter module by reflecting laser light. The laser light is reflected by the reflector toward the meter module from an obliquely lower side on the front side of the meter module. The meter module may have a cover member provided by a liquid-crystal shutter board and/or a touch panel.

### TECHNICAL FIELD

The present disclosure relates to a meter for an vehicle, which displays condition of the vehicle, and has a projector.

### BACKGROUND

A meter for vehicle having a projector device is discloses in JP2011-162194. This meter device displays condition of vehicle by a pointer meter. Furthermore, the meter device can display an image in a overlapping manner with the pointer by projecting an image, which is displayed by a light emitting display device, onto a projection surface such as a half-mirror.

### SUMMARY

According to the conventional technology, it is difficult to project a clear image due to a reflection of images other than the image displayed on the display device and an external light. There may be cases that it is possible to suppress adverse effect of the other image reflections and the external light by improving spatial relationships among the display and the projection surface, and location of the device in the vehicle. However, this solution spoils a freedom of design. In another viewpoint, it is necessary to locate the display device and the projection surface accurately, when installing those components on a dashboard of the vehicle. From such viewpoints, the meter for vehicle still needs a further improvement.

It is an object of disclosure to provide a meter with projector which is capable of projecting a clear image on the meter for displaying condition of a vehicle.

It is another object of disclosure to provide a meter with projector which is capable of projecting a clear image while not depending on location of the meter.

It is still another object of disclosure to provide a meter with projector which is easy to install onto a vehicle.

The present disclosure employs the following technical means, in order to attain the above-mentioned object. According to an embodiment of the disclosure, a meter with a projector is provided.

The meter has a meter module which is disposed on a dashboard of a vehicle in a protruding manner, and has a display device to display condition of the vehicle. The meter has a chassis module which is disposed on the dashboard to be extended on a front side of the meter module. The meter has a projector module disposed on the chassis module, which has a laser light source and a reflector, and projects an image on the meter module from the front side of the meter module by scanning laser light supplied from the laser light source.

According to the embodiment, the meter module is projected from the dashboard. The meter module displays condition of the vehicle. In addition, an image is projected on the meter module by the projection module. Since the projection module projects the image by scanning laser light, a clear image can be projected.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a cross sectional view of a meter according to a first embodiment of the present disclosure; and

FIG. 2 is a partially sectional perspective view of the meter of the first embodiment.

### DETAILED DESCRIPTION

A plurality of embodiments of the present invention are explained referring to drawings. Components and parts corresponding to the components and parts described in the preceding description may be indicated by the same reference number and may not be described redundantly. In a case that only a part of component or part is described, other descriptions for the remaining part of component or part in the other description may be incorporated. Components and parts corresponding to the components and parts described in the preceding description may be indicated by the same reference number and may not be described redundantly. The embodiments can be partially combined or partially exchanged in some forms which are clearly specified in the following description. In addition, it should be understood that, unless trouble arises, the embodiments can be partially combined or partially exchanged each other in some forms which are not clearly specified.

### First Embodiment

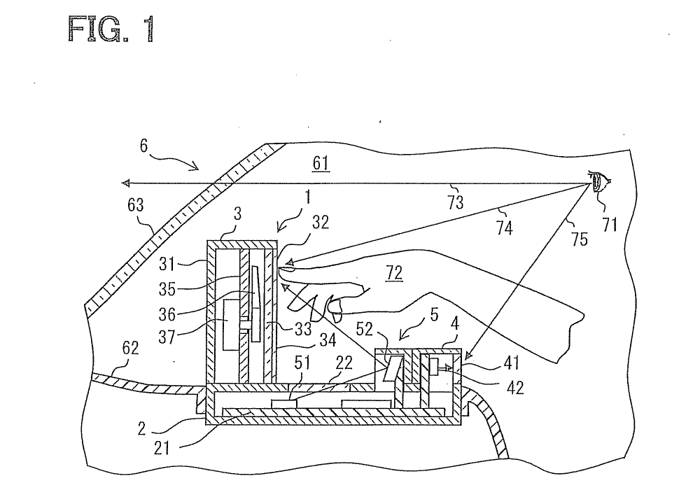

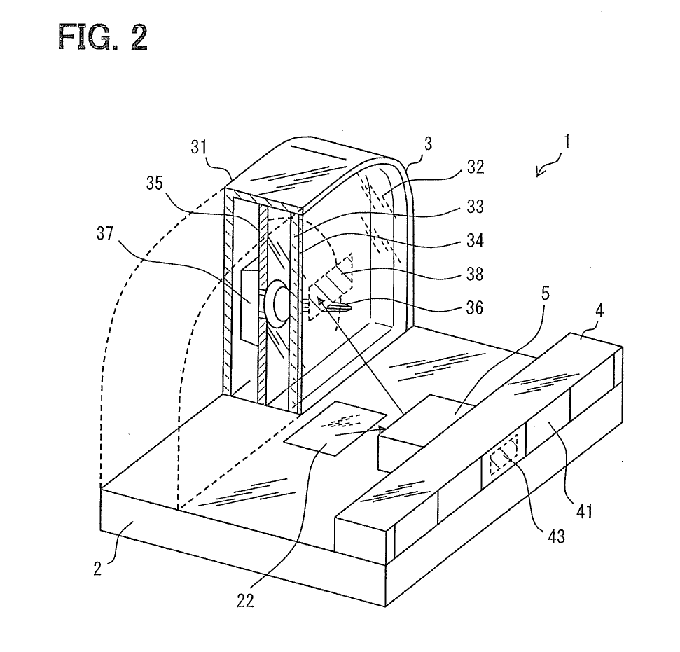

Referring to FIG. 1 and FIG. 2, a meter device 1 for a vehicle according to an embodiment is illustrated. The meter device 1 has a chassis module 2, a meter module 3, an indicator module 4, and a projector module 5. In the drawings, the right side corresponds to a rear side of the vehicle 6, and the left side is a front side of the vehicle 6. In the drawings, the right side is referred to as a front side of the meter device 1, and the left side is referred to as a back side of the meter device 1.

The meter device 1 is mounted on a vehicle 6. The meter device 1 is installed in a compartment 61 of the vehicle 6. The meter device 1 is disposed between a windshield glass 63 installed on a front side of the vehicle 6 and a user of the vehicle 6.

The meter device 1 is disposed on an upper surface of the dashboard 62 which is disposed on the front area of the compartment 61. The meter device 1 is mounted so that the chassis module 2 is placed as a part of the dashboard 62 or enclosed under the dashboard 62. The meter device 1 is mounted so that an upper surface of the chassis module 2 is placed on the same level to the upper surface of the dashboard 62. The meter module 3 is disposed on the dashboard 62 in a protruding manner so that the meter module 3 upwardly protrudes from the dashboard 62. The indicator module 4 is disposed on the dashboard 62 in a protruding manner so that the indicator module 4 upwardly protrudes from the dashboard 62.

The meter device 1 is mounted on the vehicle 6 so that both display of the meter module 3 and display of the indicator module 4 are oriented to an eye 71 of a user of the vehicle 6 including a driver and a passenger of the vehicle 6. The meter device 1 is disposed on a position to which the user can reach with a finger of user's hand 72. A line 74 of sight of the eye 71 viewing the meter module 3 is directed below a line 73 of sight of the eye 71 viewing an external view through the windshield glass 63.

A line 75 of sight of the eye 71 viewing the indicator module 4 is directed below both the line 73 and the line 74.

The chassis module 2 provides a base member which positions a plurality of components of the meter device 1 in the illustrated arrangement. The chassis module 2 is provided by a container made of resin. The chassis module 2 may also be referred to as a circuit container which accommodates a controller 21. The chassis module 2 is formed in a box shape with a flat rectangular shape. The chassis module 2 is disposed in parallel with the upper surface of the dashboard 62.

The meter module 3 is disposed on one end of the chassis module 2. The indicator module 4 is disposed on the other end of the chassis module 2. The chassis module 2 supports the meter module 3, the indicator module 4, and the projector module 5 thereon. At least the chassis module 2 and the projector module 4 are formed in a single component, i.e., an assembly unit, which can be handled as an assembly. In the embodiment, the chassis module 2, the meter module 3, the indicator module 4, and the projector module 4 are formed in an assembly unit which can be handled as a single unit.

A window 22, which can penetrate laser light which is projection light for projecting an image, is formed on the upper surface of the chassis module 2. The window 22 demonstrates high permeability to the laser light. The controller 21 has a laser light source 51 which is a light source for projection. The laser light source 51 supplies the laser light to the projector module 5 through the window 22. The laser light source 51 is also one component of the projector module 5.

The controller 21 is an ECU (Electronic Control Unit). The controller has processing unit (CPU) and a memory device (MMR) as a storage medium which memorizes a program. The control device is provided with a microcomputer having a storage medium readable by a computer. The storage medium is a non-transitory storage medium which stores a program readable by the computer. The storage medium can be provided by a solid state memory device or a magnetic disc memory. The program, when executed by the control device, makes the control device to function as devices described in this specification, and makes the controls device to perform a control method described in this specification. The means provided by the control device may be referred to as a functional block or a module which performs a predetermined function.

The meter module 3 is disposed so as to be upwardly protruded from the upper surface of the dashboard 62. The meter module 3 is disposed on the chassis module 2. The meter module 3 has a case 31 formed in a flat dish shape. The case 31 is fixed to a front end which is an end portion of the chassis module 2 located on a front side of the vehicle 6.

The cover member 32 is disposed on an open end of the case 31. The cover member 32 covers a display device disposed within the case 31 and allows the user to see the display device from an outside. The cover member 32 is disposed to face the user. A front surface of the cover member 32 faces the user. The cover member is provided by a liquid-crystal shutter board 33 and a touch panel 34. The touch panel 34 is disposed on an outside surface of the liquid crystal shutter board 33. The liquid crystal shutter board 33 can change a light permeability. The liquid crystal shutter board 33 can be switched between a transparent state which enables light to pass so that the user can see the display device in the case 31, and an opaque state which intercepts light so that the display device in the case 31 is hidden from the user. The liquid crystal shutter board 33 is capable of switching between a visible state in which the display device is visible and an invisible state in which the display device is invisible. The touch panel 34 covers a front face of the liquid crystal shutter board 33. The touch panel 34 detects a touch of body of the user, e.g., a touch of finger, and outputs a signal which indicates a position where the user touched to the controller 21.

A dial board 35 is disposed between the case 31 and the liquid crystal shutter board 33. The dial board 35 divides a cavity in the case 31 into a front display cavity which is visible from the user and a back machine cavity hidden from the user. Scales and characters giving a meter appearance are printed on a front face, which faces the user, of the dial board 35. A pointer 36 is arranged between the dial board 35 and the liquid crystal shutter board 33. A drive device 37, which moves the pointer 36, is arranged between the case 31 and the dial board 35. The drive device 37 can be provided by a motor such as a step motor having a shaft connected with the pointer 36. The pointer 36 and the drive device 37 provide the display device. The display device may be referred to as a pointer meter.

The indicator module 4 is fixed on the chassis module 2. The indicator module 4 is disposed so as to be upwardly protruded from the upper surface of the dashboard 62. The indicator module 4 has a plurality of display surfaces 41 and is disposed to direct the display surfaces 41 to the user. The indicator module 4 is disposed on an end of the chassis module 2 located on the front side of the meter module 3, and displays a character or a sign to the user.

The indicator module 4 has the plurality of display surfaces 41 and a plurality of light sources 42 disposed behind the display surfaces 41, respectively. A pattern 43 of the character or the sign corresponding to the information to be given to the user is formed on the display surface 41. The light source 42 displays the pattern 43 by illuminating the display surface 41 from a back side when it is turned on. When the light source 42 is turned off, the display surface 41 is dark and the pattern 43 is not displayed.

The projector module 5 is fixed on the chassis module 2. The projector module 5 is disposed so as to be upwardly protruded from the upper surface of the dashboard 62. The projector module 5 is arranged so that at least a part of the projector module 5 is hidden behind the indicator module 4 to the user. The projector module 5 has the laser light source 51 mounted on the controller 21, i.e., the chassis module 2. The projector module 5 has a reflector 52 which reflects the laser light outputted from the laser light source 51 to the cover member 32.

The meter module 3 is disposed on one end of the chassis module 2, and the reflector 52 is disposed on the other end of the chassis module 2. The reflector 52 is provided on one end of the chassis module 2 at the front side of the meter module 3. The reflector 52 is positioned behind the indicator module 4.

The laser light source 51 may be a single-color laser light source or a multi-color laser light source which can supply light for displaying an image 38. The laser light source 51 may be provided with a color light source having laser light sources of RGB colors. The laser light source 51 is disposed on the controller 21 at a position between the meter module 3 and the reflector 52.

The reflector 52 is a movable reflector which has a mirror for reflecting the laser light and a driving mechanism for oscillating the mirror in a high speed oscillating manner. The reflector 52 is a scanner mechanism for projecting the image 38 on the front face of the cover member 32 by scanning the laser light in a two dimensional manner. The reflector 52 may be provided by the galvanometer mirror or a MEMS (Micro Electro Mechanical System) scanner mirror.

The image 38 is displayed on the cover member 32 by synchronously controlling the laser light source 51 and the reflector 52. The image 38 is formed closer to the user than the dial board 35 and the pointer 36. The image 38 covers at least a part of the dial board 35 and the pointer 36.

The projection module 5 projects the image 38 on the meter module 3 from an obliquely lower side on the front side of the meter module 3. That is, the laser light source 51 and the reflector 52 supply laser light towards the cover member 32 from the front side of the meter module 3, and from a lower side relative to the meter module 3. The projection module 5 projects the image 38 on the meter module 3 by reflecting laser light. The laser light is supplied from the laser light source 51 toward the front side of the meter module 3. The laser light is reflected by the reflector 52 toward the meter module 3 from an obliquely lower side on the front side of the meter module 3.

The projector module 5 irradiates scanned laser light from the front side of the meter module 3 onto the meter module 3. Therefore, the scanned laser light is irradiated in a counter direction to the user, without directed to the user. The projector module 5 irradiates the scanned laser light obliquely from a lower side to an upper side. A scan field of the laser light by the projector module 5 may cover the entire front surface of the meter module 3 or a part thereof.

Path of the laser light is defined within a region surrounded by three components of the chassis module 2, the meter module 3, and the indicator module 4 or the projector module 5. The user may hold the hand 72 above the dashboard 62 to try to touch the touch panel 34, when the image 38 is projected. In this case, as shown in the drawing, even the user holds the hand 72 over the dashboard 62, the laser light can reach the cover member 32 through under the hand 72. The user can see the image 38 just before the hand 72 touches the touch panel 34. Therefore, the user can surely touch the location indicated by the image 38 correctly.

The controller 21 controls the meter module 3 and the projector module 5. In addition, the controller 21 controls the meter module 3, the indicator module 4, and the projector module 5.

The controller 21 controls the drive device 37, e.g., a motor in the meter module 3. The controller 21 provides a meter control section which displays condition of the vehicle 6 on the meter module 3 by controlling the meter module 3. As a result, the meter module 3 functions as a pointer meter. The meter module 3 displays condition of the vehicle 6. The meter module 3 may function as, for example a speedometer, a tachometer, a coolant temperature gauge, or a fuel gauge.

The controller 21 controls the light source disposed in the indicator module 4.

The controller 21 provides an indicator control section which displays information, including warning etc., by controlling the indicator module 4.

The controller 21 controls the projector module 5. The controller 21 provides a projection control section which projects an image 38 on the meter module 3 by controlling the laser light source 51 and the reflector 52 in a synchronous manner. The projection control section controls the laser light source 51 and the reflector 52 in a synchronous manner to project the image 38 on the front face of the cover member 32.

The image 38 may include a character, such as a number indicating condition of the vehicle 6, and a message to the user. The image 38 may be a movie or an animation, such as a view of outside and a broadcast movie, or a still image. The image 38 may be a symbol or sign, such as an icon or button for encouraging the user to operate the touch panel 34.

In addition, the controller 21 controls the liquid crystal shutter board 33. The controller 21 provides a display surface control section which performs a switching control of the liquid crystal shutter board 33 between the transparent state and the opaque state. When the liquid crystal shutter board 33 is in the transparent state, the user can see the pointer 37 and the dial board 35 of the meter module 3. When the liquid crystal shutter board 33 is in the opaque state, the user cannot see the pointer 37 and the dial board 35 of the meter module 3. When the liquid crystal shutter board 33 is in the opaque state, the user can easily recognize the image 38.

The controller 21 may provide a warning control section which controls the projector module 5 to project the image 38 for giving the user warning on the front face of the cover member 32, when the speed of the vehicle exceeds a predetermined threshold value. The controller 21 may provide an input control section. The input control section controls the liquid crystal shutter board 33 in the opaque state, when it is necessary to input a command from the user. In addition, the input control section controls the projector module 5 to project the image 38 of an icon, which requires touch operation of the touch panel 34 to the user, on the cover member 32 where the pointer meter is hidden. The controller 21 may provide a response control section which inputs the signal indicative of touching of the hand 72 on a position corresponding to the image 38 of the icon from the touch panel 34, and performs predetermined control processing in response to the input signal.

As explained above, the meter device 1 has the projector module 5 which scans the laser light supplied from the laser light source 51 by the reflector 52. Therefore, it is possible to project a clear image 38 on the front face of the cover member 32, while suppressing adverse effect of external images reflected on the front face of the cover member 32 or external incoming light.

The meter device 1 has the projector module 5 disposed on the chassis module 2. This arrangement contributes to improve positioning accuracy of the projector module 5. The laser light source 51 and the reflector 52, which configure an optical system, are correctly positioned relatively with each other by the chassis module 2.

In addition, the meter device 1 has the meter module 3 and the projector module 5 both of which are disposed on the chassis module 2. This arrangement contributes to position correctly the meter module 3 and the projector module 5 for projecting the image. The laser light source 51, the reflector 52 and the cover member 32, which configure an optical system, are correctly positioned relatively with each other by the chassis module 2.

The chassis module 2 and the projector module 5 can be handled as a single component in a stage for assembling it on the vehicle 6. Therefore, it is possible to assemble the meter device 1 on the vehicle 6, i.e., the dashboard 62, while accurately positioning the laser light source 51 and the reflector 52 relatively. In detail, the meter module 1 having the chassis module 2, the meter module 3 and the projector module 5 is formed in an assembly unit which can be handled as a single unit. The meter device 1 can be installed on the vehicle 6, i.e., on the dashboard 62, while being accurately positioning relative positions of the laser light source 51, the reflector 52, and the cover member 32.

The meter device 1 allows it to handle the meter module 3 and the indicator module 4 as a single unit part. In addition, the meter device 1 enables an arrangement in which the meter module 3 is disposed a far side to the user and the indicator module 4 is disposed on a near side to the user.

The meter device 1 has the touch panel 34 on the cover member 32. Therefore, the user can give a command to the controller 21 by operating the touch panel 34. The user can operate the touch panel 34 based on the image 38 projected on the meter module 3 by the projector module 5. In addition, the projector module 5 projects the image 38 to the cover member 32 from the obliquely lower side on the front side of the cover member 32. Therefore, the projector module 5 can project and display the image 38, without being interrupted by the hand 72 held to operate the touch panel 34. The user can see the image 38 just before touching the image 38.

The meter device 1 has the liquid crystal shutter board 33 on the cover member 32. The liquid crystal shutter board 33 may be controlled in the opaque state when the image 38 is projected. Therefore, the dial board 35 and the pointer 36 are hidden when the liquid crystal shutter board 33 is in the opaque state. As a result, it is possible to attract attention of the user when the image 38 is projected. In another aspect, it is possible to display the image 38 clearly.

### Other Embodiments

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

The preferred embodiments of the disclosure have been described. However, the disclosure is not limited to the above embodiments, and the above embodiments may be modified in various ways without departing from the spirit and scope of the invention. The configuration of the above described embodiments is just examples. The disclosure in its broader terms is therefore not limited to the specific details, representative apparatus, and illustrative examples shown and described. The plurality of disclosed inventions may be practiced independently, respectively, without being limited to the combination shown in the embodiments. The extent of the disclosure is shown by the scope of the claims, and also includes the changes, which is equal to and within the same range of the scope of the claim.

For example, means and functions provided by the control device can be provided by only software, by only hardware, or those combinations. For example, the control device may be configured by an analog circuit.

In the embodiment, the meter module 3 is provided with a display device which has the pointer 36 and the drive device 37. Alternatively, the meter module 3 may be provided with an image display device such as a liquid crystal display.

In the embodiment, the image 38 is projected on the front face of the cover member 32. Alternatively, the image 38 may be projected on the front face of the dial board 35.

In the embodiment, the projector module 5 is provided by the laser light source 51 disposed on the controller 21 and the movable reflector 52 disposed behind the indicator module 4. Alternatively, the projector module 5 may be provided by a fixed reflector 52 disposed behind the indicator module 4. In this case, an additional movable reflector may be disposed on the controller 21 in order to scan the laser light from the laser light source 51 and direct the laser light to the fixed reflector 52. This arrangement can also project the image 38 on the meter module 3.

In the embodiment, both the meter module 3 and the projector module 5 are disposed on the chassis module 2. Alternatively, the chassis module 2 and the meter module 3 can be formed as separatable components. For example, the chassis module 2 and the meter module 3 may be disposed and fixed independently on the dashboard 62.

In the embodiment, the cover member 32 is provided by the liquid crystal shutter board 33 and the touch panel 34. Alternatively, the cover member 32 may be provided by the liquid crystal shutter board 33 or the touch panel 34. Furthermore, the cover member 32 may be provided by a transparent glass or acrylic board.

What is claimed is:

1. A meter with a projector comprising:
a meter module which is disposed on a dashboard of a vehicle in a protruding manner, and has a display device to display condition of the vehicle;
a chassis module which is disposed on the dashboard to be extended on a front side of the meter module; and
a projector module disposed on the chassis module, which has a laser light source and a reflector, and which projects an image on the meter module from the front side of the meter module by scanning laser light supplied from the laser light source.

2. The meter with a projector claimed in claim 1, wherein
the meter module is disposed on the chassis module,
the reflector is disposed on one end of the chassis module at the front side of the meter module, and
the projection module projects the image on the meter module from an obliquely lower side on the front side of the meter module.

3. The meter with a projector claimed in claim 2, further comprising:
an indicator module disposed on one end of the chassis module at the front side of the meter module, which displays a character or a sign, wherein
the reflector is disposed behind the indicator module.

4. The meter with a projector claimed in claim 2, wherein
the meter module is disposed on one end of the chassis module, and
the reflector is disposed on the other end of the chassis module.

5. The meter with a projector claimed in claim 1, wherein
the meter module includes a cover member which covers the display device, and
the projector module projects the image on the cover member.

6. The meter with a projector claimed in claim 5, wherein
the cover member includes a liquid crystal shutter board which is capable of switching between a visible state in which the display device is visible and an invisible state in which the display device is invisible.

7. The meter with a projector claimed in claim 1, wherein
the cover member includes a touch panel which detects touch of a user body.

8. The meter with a projector claimed in claim 1, wherein
the chassis module includes a controller which controls the meter module and the projector module.

9. The meter with a projector claimed in claim 1, further comprising:
an indicator module disposed on one end of the chassis module at the front side of the meter module, which displays a character or a sign, wherein
the chassis module includes a controller which controls the meter module, the indicator module, and the projector module, and wherein
the meter module is disposed on the chassis module so that the chassis module, the meter module, the indicator module, and the projector module are formed in an assembly unit which can be handled as a single unit, and wherein
the reflector is disposed on one end of the chassis module at the front side of the meter module, and wherein
the reflector is a movable reflector which scans the laser light supplied from the laser light source, and is disposed behind the indicator module, and wherein
the laser light source is disposed on the controller at a position between the meter module and the reflector, and wherein
the projection module projects the image on the meter module by reflecting laser light supplied from the laser light source toward the front side of the meter module,
the laser light being reflected by the reflector toward the meter module from an obliquely lower side of the front side of the meter module.
